(19) United States
(12) Patent Application Publication
(10) Pub. No.: US 2025/0374080 A1
(43) Pub. Date: Dec. 4, 2025

(54) ABSTRACTION LAYER FOR NETWORK ANALYTICS

(71) Applicant: Microsoft Technology Licensing, LLC, Redmond, WA (US)

(72) Inventors: Bozidar RADUNOVIC, Cambridge (GB); Xenofon FOUKAS, Cambridge (GB); Ganesh ANANTHANARAYANAN, Redmond, WA (US); Matthew BALKWILL, Trowbridge (GB)

(21) Appl. No.: 18/679,128

(22) Filed: May 30, 2024

(51) Int. Cl. H04W 24/02

(52) U.S. Cl. CPC H04W 24/02

(57) ABSTRACT

Example implementations include a method, apparatus, and computer-readable medium configured for performing selected operations on selected data streams at one or more optimized locations within a communications network. The apparatus receives a selection of data elements available from one or more codelets operating within a network function or operating system of nodes of the communications network, each data element associated with a schema defining output from the codelet. The apparatus receives a selection of operations to perform on the selected data elements. The apparatus generates a streaming query representation of the algorithm for performing the operations on respective streams of the data elements. The apparatus selects a location for performing the streaming query based on bandwidth and latency constraints. The apparatus outputs code in a programing language corresponding to an architecture of the selected location to perform the streaming query.

### TECHNICAL FIELD

The present disclosure relates to communications networks and, in particular, to an abstraction layer for network analytics.

### BACKGROUND

A radio access network (RAN) may provide multiple user devices with wireless access to a network. The user devices may wirelessly communicate with a base station, which forwards the communications towards a core network. Conventionally, a base station in the RAN is implemented by dedicated processing hardware (e.g., an embedded system) located close to a radio unit including antennas. The base station may perform lower layer processing including physical (PHY) layer and media access control (MAC) layer processing for one or more cells. There may be costs associated with deploying dedicated processing hardware for each base station in a RAN, particularly for a RAN including small cells with relatively small coverage areas. Additionally, the dedicated processing hardware may be a single point of failure for the cell.

A virtualized radio access network may utilize an edge datacenter with generic computing resources for performing RAN processing for one or more cells. That is, instead of performing PHY and MAC layer processing locally on dedicated hardware, a virtualized radio access network may forward radio signals from the radio units to the edge datacenter for processing and similarly forward signals from the edge datacenter to the radio units for wireless transmission. In one specific example, cloud-computing environments can be used to provide mobile edge computing (MEC) where certain functions of a mobile network can be provided as workloads on nodes in the cloud-computing environment. In MEC, a centralized unit (CU) can be implemented in a back-end node, one or more distributed units (DUs) can be implemented in intermediate nodes, and various remote units (RU), which can provide at least PHY and/or MAC layers of a base station or other RAN node of the mobile network, can be deployed at edge servers. The RUs can communicate with the CU via one or more DUs. In an example, the DUs can provide higher network layer functionality for the RAN, such as radio link control (RLC) or packet data convergence protocol (PDCP) layer functions. The RUs can facilitate access to the CU for various downstream devices, such as user equipment (UE), Internet-of-Things (IoT) devices, etc.

Because the edge datacenter utilizes generic computing resources, a virtualized RAN may provide scalability and fault tolerance for base station processing. For example, the edge datacenter may assign a variable number of computing resources (e.g., servers) to perform PHY layer processing for the radio units associated with the edge datacenter based on a workload. Further, a virtualized RAN may implement multiple layers of RAN processing at different datacenters, enabling collection of multiple data feeds. The collection of data feeds, however, also consumes network resources for both collecting and processing the data feeds. Accordingly, there is a need for efficient management of data feeds.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus including: one or more memories storing computer executable instructions; and one or more processors coupled with the one or more memories and, individually or in combination, configured to: receive a selection of data elements available from one or more codelets operating within a network function or an operating system of one or more nodes of a communications network, each data element associated with a schema defining output from a respective codelet; receive a selection of operations to perform an algorithm on one or more of the selected data elements; generate a streaming query that represents the algorithm for performing the operations on respective streams of the selected data elements; select a location for performing the streaming query based on bandwidth and latency constraints; and output code in a programing language corresponding to an architecture of the selected location to perform the streaming query.

In some aspects, the techniques described herein relate to a method including: receiving a selection of data elements available from one or more codelets operating within a network function or an operating system of one or more nodes of a communications network, each data element associated with a schema defining output from a respective codelet; receiving a selection of operations to perform an algorithm on one or more of the selected data elements; generating a streaming query that represents of the algorithm for performing the operations on respective streams of the selected data elements; selecting a location for performing the streaming query based on bandwidth and latency constraints; and outputting code in a programing language corresponding to an architecture of the selected location to perform the streaming query.

In some aspects, the techniques described herein relate to a non-transitory computer-readable medium having computer-executable instructions stored thereon, the instructions when executed by a computer processor cause the computer processor to: receive a selection of data elements available from one or more codelets operating within a network function or an operating system of one or more nodes of a 5G radio network, each data element associated with a schema defining output from a respective codelet; receive a selection of operations to perform an algorithm on one or more of the selected data elements; generate a streaming query that represents the algorithm for performing the operations on respective streams of the selected data elements; select a location for performing the streaming query based on bandwidth and latency constraints; and output code in a programing language corresponding to an architecture of the selected location to generate inputs to a machine-learning model by performing the streaming query.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example virtualized radio access network (vRAN) including an abstraction layer for network analytics.

FIG. 2 is a conceptual diagram of an example of an architecture for a system to generate code for performing selected operations on selected data streams at one or more optimized locations within a communications network.

FIG. 3 is a schematic diagram of an example of an apparatus (e.g., a computing device) for generating code for performing selected operations on selected data streams at one or more optimized locations within a communications network.

FIG. 4 is a flow diagram of an example of a method for generating code for performing selected operations on selected data streams at one or more optimized locations within a communications network (e.g., a 5G network).

FIG. 5 illustrates an example of a device including additional optional component details as those shown in FIG. 3.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to processing of data streams generated in a communications network. The data streams may be generated by codelets embedded within network functions or operating systems of various network nodes. The data streams may be used by various applications for network management and control. For example, the data streams may provide input to a machine-learning model of an application for network analysis or control. For instance, an application may perform tasks such as scheduling, load balancing, or anomaly detection. Some of these tasks may have tight timing or bandwidth constraints, for example, due to radio timing designs. The location where a task is performed in a network may affect latency and bandwidth. In general, latency is lower at an edge of the network, but processing resources are more limited. In contrast, central datacenters may have greater computing resources, but there is latency associated with moving data to the central datacenters. Further, moving large quantities of data, such as low-level radio measurements may consume significant bandwidth. Additionally, although applications may be executed at different locations within a network (e.g., types of datacenter), the locations may have different frameworks that require applications to be written in different programming languages.

The present disclosure provides an abstraction layer that facilitates creation of efficient data processing pipelines for making decisions based on data streams collected from various network functions. The abstraction layer provides tools for identifying data streams and operations that can be performed on such streams. The abstraction layer can represent an algorithm for processing the data streams as a streaming query. The abstraction layer may then select a location for performing the streaming query based on bandwidth and latency constraints. The abstraction layer may output code in a programming layer corresponding to the architecture of the selected location to generate inputs for a machine learning model.

Implementations of the present disclosure may realize one or more of the following technical effects. Abstraction of a data processing algorithm away from code tied to a system architecture allows selection of different network locations to perform data processing in order to optimize based on bandwidth and latency constraints applicable to a network environment. This flexibility allows optimization of data collection for a machine-learning model, which improves performance of the network via use of a machine-learning model to make real-time decisions and also reduces overhead of such decisions. In some implementations, the selection of network location may also optimize compute resources. Some edge deployments may have more or less CPU real estate available for query processing. In these cases the CPU utilization will be a third parameter to optimize, which can provide faster results or less delay to other applications.

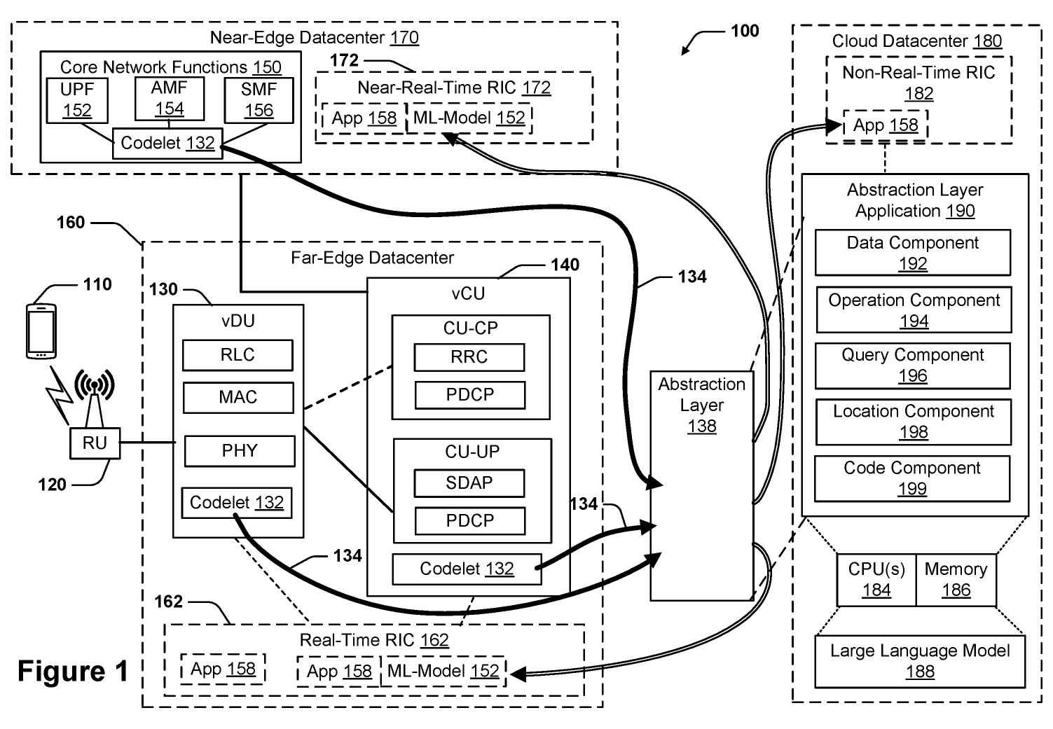

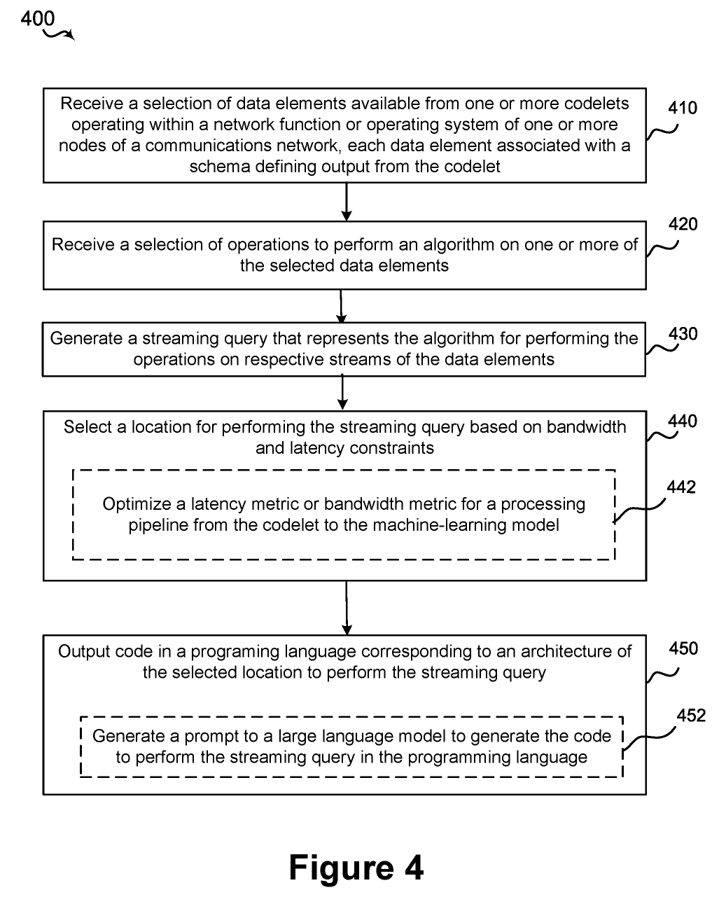

Turning now to FIGS. 1-5, examples are depicted with reference to one or more components and one or more methods that may perform the actions or operations described herein, where components and/or actions/operations in dashed line may be optional. Although the operations described below in FIG. 4 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a diagram of an example vRAN 100 that provides connectivity to a user equipment (UE) 110. For example, the vRAN 100 may implement a 5G communications network. The vRAN 100 may include radio units 120 that transmit and receive wireless signals with the UE 110. The vRAN 100 may include a virtual distributed unit (vDU) 130 that performs processing, for example, at the physical (PHY) layer, media access control (MAC) layer, and radio link control (RLC) layer. The vRAN 100 may include a virtual central unit (vCU) 140 that performs processing at higher layers of the wireless protocol stack. The vRAN 100 may include core network functions 150 that provide user and session management.

The division of functionality between the vDU 130 and the vCU 140 may depend on a functional split architecture. The vCU 140 may be divided into a central unit control plane (CU-CP) and central unit user plane (CU-UP). CU-UP may include the packet data convergence protocol (PDCP) layer and the service data adaptation (SDAP) layer, and the radio resource control (RRC) layer. Different components or layers may have different latency and throughput requirements. For example, the PHY layer may have latency requirements between 125 µs and 1 ms and a throughput requirement greater than 1 Gbps, the MAC and RLC layers may have latency requirements between 125 µs and 1 ms and a throughput requirement greater than 100 Mbps, and the higher layers at the vCU may have latency requirements greater than 125 µs and a throughput requirement greater than 100 Mbps.

Higher layer network functions may be referred to as core network functions 150. For example, the core network functions may include one or more Access and Mobility Management Functions (AMFs), a Session Management Function (SMF), and a User Plane Function (UPF). These network functions may provide for management of connectivity of the UE 110. For example, the UPF may provide processing of user traffic to and from the Internet. For instance, a UPF may receive user traffic packets and forward the packets to a server via one or more routers using Internet protocol.

In some implementations, the vRAN 100 includes a RAN intelligent controller (RIC) that performs autonomous configuration and optimization of the vRAN 100. The RIC is implemented at multiple locations as at least a real-time RIC 162 and a near-real-time RIC 172 or a non-real-time RIC 182. For instance, the real-time RIC 162 is executed at a far-edge datacenter 160 that also executes a vRAN function such as the vDU 130 or the vCU 140. The near-real-time RIC 172 is executed at a near-edge datacenter 170. The non-real-time RIC 182 may be executed at either the near-edge datacenter 170 or a cloud datacenter 180. In an aspect, each datacenter is associated with a set of computing resources. For example, the computing resources at the far-edge datacenter 160 are a first set of computing resources and the computing resources at the near-edge datacenter 170 are a second set of computing resources.

Programmability in vRAN functions (e.g., Open RAN components) may be facilitated through the codelets 132 and the RIC. A network operator can install applications (Apps 158, e.g., xApps in Open RAN) on top of any of the real-time RIC 162. the near-real-time RIC 172, or the non-real-time RIC 182. Each RIC may collect network data from the network functions using the codelets 132 and may leverage the network data to optimize network performance or report issues on a time-frame based on location. For example, a real-time RIC may operate with latency less than 10 milliseconds (ms); the near-real-time RIC 172 may operates with latency greater than 10ms to seconds; and the non-real-time RIC 182 may operate with latency greater than 10 seconds. The RICs may obtain the network data from various sources. For example, the data collection and control of the vRAN components may be facilitated through service modelsthat are embedded in the vRAN functions by vendors. The service models may explicitly define the type and frequency of data reporting for each App 158, as well as a list of control policies that the RIC can use to modify the RAN behavior. Such services models may collect significant network events occur at a relatively low rate (100s of ms to seconds), which is suitable for the near-real-time RIC 172 and the non-real-time RIC 182.

The codelets 132 may provide additional data collection capabilities beyond the vendor defined service models. A dynamic service model may define hook points and operational data that can be accessed by a codelet 132 at each hook point. Once a codelet is installed within a network function, the codelet 132 may be associated with a schema that defines output from the codelet. For example, the schema may define data elements that may be collected to form a respective data stream 134.

In an aspect, an abstraction layer 138 provides an interface between the data streams produced by the codelets and a user (e.g., a network operator) that utilizes the data streams for providing data to an app 158. The abstraction layer 138 may receive the dynamic service models and/or the schemas that define available output from codelets 132. The abstraction layer 138 provides a user interface that allows the user to select data streams that are available within the network without the user needing to program or be familiar with the low-level programming of the codelets 132. For instance, the user interface may list the available data streams in a hierarchical menu or graphical representation thereof that allows the user to select data streams by source or by type of data. The abstraction layer 138 may further provide a menu of operations that may be performed on the data streams. For example, the operations may include statistical operations that are useful for analysis of streaming data such as tail, percentile, windowed averages, decay functions, etc.

Once the abstraction layer has received the selected data elements and operations, the abstraction layer optimizes processing of the data streams based on bandwidth and latency constraints to efficiently perform an algorithm for performing the selected operations. For example, the codelet 132 at the vDU 130 may have access to bulky data such as complex valued measurements received from the RU 120. If the user selects such data and operations to be performed on the data, the abstraction layer 138 may determine whether the operations should be performed at the far edge datacenter 160, or if the data should be sent to the near-edge datacenter 170 for processing. The decision may depend on availability of processing resources at the far-edge datacenter 160 and the near-edge datacenter 170, the difference in bandwidth for transmitting raw data versus data processed according to the operations, and other data that may be combined with the requested data in later stages.

Once the abstraction layer 138 has selected a location for performing an operation, the abstraction layer 138 facilitates generation of code for implementing the operation at the selected location. One difficulty in optimizing processing pipelines is that different types of datacenters may have different architectures for programmability. For instance, a far-edge datacenter 160 may be designed for low-latency execution of network functions. Programmability through codelets 132 and/or apps 158 may require use of low-level programming languages such as C or verification of safety through eBPF. In contrast, a cloud datacenter 180 may allow programmability though use of virtual machines, workload management services or other abstractions. Accordingly, computer code for performing an operation may vary based on the selected location for performing the operation. The abstraction layer 138 may use a streaming query representation of the algorithm for performing the operations. The abstraction layer 138 may utilize programmatic or large language model (LLM) based techniques for converting the streaming query language representation into executable code in a programming language corresponding to the architecture of the selected location. The abstraction layer 138 may then form a processing pipeline for performing the selected operations at one or more locations.

Large Language Model (LLM) is a term that refers to artificial intelligence or machine-learning models that can generate natural language texts from large amounts of data. Large language models use deep neural networks, such as transformers, to learn from billions or trillions of words, and to produce texts on any topic or domain. Large language models can also perform various natural language tasks, such as classification, summarization, translation, generation, and dialogue.

In an aspect, the abstraction layer 138 may be implemented as an abstraction layer application 190, which may be instantiated at a datacenter such as the cloud datacenter 180. The abstraction layer application 190 may include a data component 192, an operation component 194, a query component 196, a location component 198, and a code component 199. The data component 192 is configured to receive a selection of data elements available from one or more codelets operating within a network function or operating system of one or more nodes of a communications network, each data element associated with a schema defining output from the codelet. The operation component 194 is configured to receive a selection of operations to perform an algorithm on one or more of the selected data elements. The query component 196 is configured to generate a streaming query representation of the algorithm for performing the operations on respective streams of the data elements. The location component 198 is configured to select a location for performing the streaming query based on bandwidth and latency constraints. The code component 199 is configured to output code in a programing language corresponding to an architecture of the selected location to generate inputs to a machine-learning model 152 by performing the streaming query.

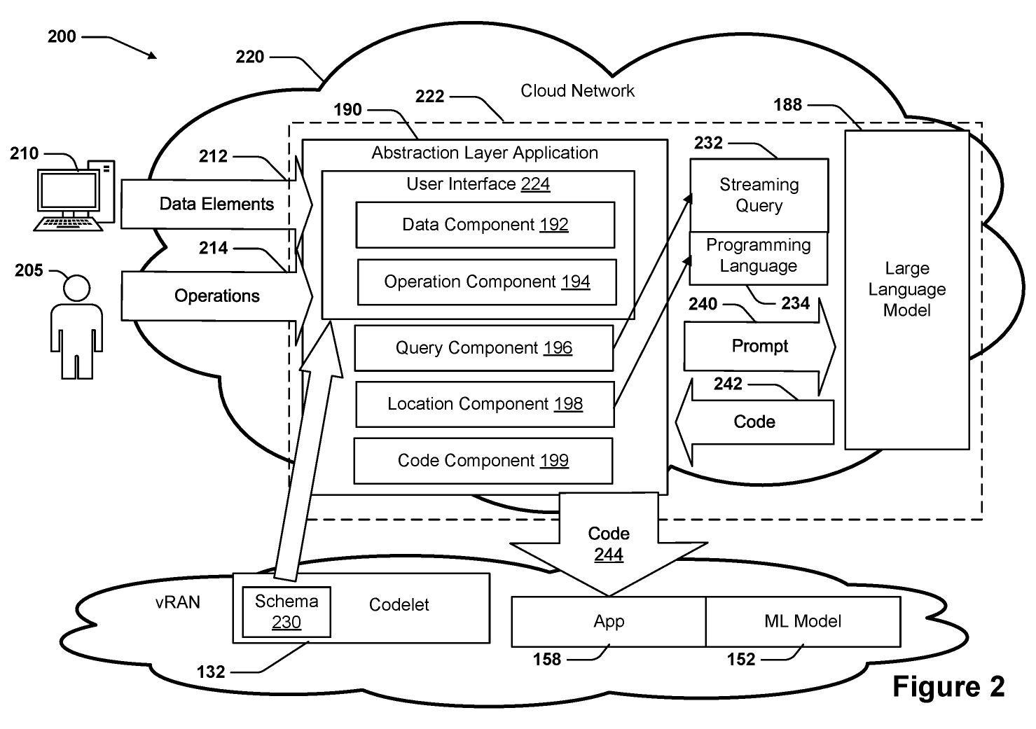

FIG. 2 is a conceptual diagram 200 of an example of an architecture for a system 220 to generate code for performing selected operations on selected data streams at one or more optimized locations within a communications network. The system 220 may be, for example, a cloud network including computing resources (e.g., at a cloud datacenter 180) that are controlled by a network operator and accessible to clients such as a user device 210 operated by a user 205. In some implementations, the client may be an operator of the vRAN 100. For example, the system 220 may include a plurality of datacenters 222 (e.g., far-edge datacenter 160, near-edge datacenter 170, or cloud datacenter 180) that include computing resources such as computer memory and processors. In some implementations, the datacenters 222 may host a compute service that provides computing nodes on computing resources located in the datacenter. The computing nodes may be containerized execution environments with allocated computing resources. For example, the computing nodes may be virtual machines (VMs), process-isolated containers, or kernel-isolated containers. The nodes may be instantiated at a datacenter 222 and imaged with software (e.g., operating system and applications for a service). The system 220 may include edge routers that connect the datacenters 222 to external networks such as internet service providers (ISPs) or other autonomous systems (ASes) that form the Internet.

The system 220 may provide a large language model (LLM) 188 that is configured to receive a natural language prompt and output a response. The LLM 188 may be a specific instance or version of a LLM artificial intelligence that has been trained and fine-tuned on a large corpus of text. The LLM may be a Generalized Pre-trained Transformer (GPT) model. For example, a GPT model may include millions or billions of parameters trained on vast amounts of data (e.g., gigabytes or terabytes of text). A GPT model is a type of neural network that uses a transformer architecture to learn from large amounts of text data. The model has two main components: an encoder and a decoder. The encoder processes the input text and converts it into a sequence of vectors, called embeddings, that represent the meaning and context of each word. The decoder generates the output text by predicting the next word in the sequence, based on the embeddings and the previous words. The model uses a technique called attention to focus on the most relevant parts of the input and output texts, and to capture long-range dependencies and relationships between words. The model is trained by using a large corpus of texts as both the input and the output, and by minimizing the difference between the predicted and the actual words. The model can then be fine-tuned or adapted to specific tasks or domains, by using smaller and more specialized datasets. For example, the LLM 188 may be tuned for converting streaming query representations into code in a set of programming languages. For instance, the LLM 188 may be tuned on a training set of example streaming queries and code in each of the programming languages.

The LLM 188 may provide an application programming interface (API) that allows other applications to interact with the LLM 188. For example, the API may allow a user or application to provide a prompt to the LLM 188. Prompts are the inputs or queries that a user or a program gives to an LLM AI, in order to elicit a specific response from the model. Prompts can be natural language sentences or questions, or code snippets or commands, or any combination of text or code, depending on the domain and the task. Prompts can also be nested or chained, meaning that the output of one prompt can be used as the input of another prompt, creating more complex and dynamic interactions with the model.

The abstraction layer application 190 may be an application that interfaces between the user 205, the vRAN 100, and optionally the LLM 188. For example, the abstraction layer application 190 may provide a graphical user interface 224 on the user device 210 for the user 205. For example, the graphical user interface 224 may include the data component 192, which displays available data elements, and the operation component 194, which displays available operations to perform on the data elements. The data component 192 may derive the available data elements from schemas 230 of codelets 132 that are installed in the vRAN 100. The data component 192 may receive a selection of data elements 212 from the user 205 via the user device 210. The operation component 194 may receive the selected operations 214 from the user 205 via the user device 210.

The query component 196 is configured to generate a streaming query 232 that represents the algorithm for performing the operations on respective streams 134 of the data elements 212. The streaming query 232 may be written in a query language that is similar to SQL. The streaming query 232 can express simple pass-through logic to move event data from one input stream into an output data store, or it can do rich pattern matching and temporal analysis to calculate aggregates over various time windows. The streaming query 232 can join data from multiple inputs to combine streaming events, and can do lookups against static reference data to enrich the event values. In some implementations, each operation may be associated with a set of query statements. The selected data elements may be inserted into the query statements as indicated by the user.

The location component 198 is configured to select a location for performing the streaming query based on bandwidth and latency constraints. For example, the location component 198 may determine the bandwidth and latency constraints based on network configuration and requirements for the app 158 that uses the requested data. In some implementations, the location component 198 may select any location that can satisfy the bandwidth and latency constraints. In some implementations, the location component 198 may be configured to optimize a latency metric or bandwidth metric for a processing pipeline from the codelet to the machine-learning mode. For instance, the location component 198 may utilize a greedy algorithm or Bayesian optimizer to allocate resources for performing the streaming query with the latency metric or bandwidth metric as a utility function. As another example, the location component 198 may utilize general linear optimization models and linear programming (with some loss of accuracy). The location component 198 may select one or more locations for performing the streaming query or portions thereof. In some implementations, the location component 198 may select from a plurality of datacenters, where at least two of the datacenters have different architectures. The location component 198 may output the locations and/or a programming language 234 corresponding to an architecture for each location. In some implementations, the location component may use an online approach in which a selected configuration is deployed, run and measured, and if needed parts are redeployed in real time.

The code component 199 is configured to output code 244 in a programing language corresponding to an architecture of the selected location to generate inputs to a machine-learning model 152 by performing the streaming query 232. In some implementations, the code component 199 may programmatically convert a streaming query 232 into code 244. For instance, a programming language such as MICROSOFT KUSTO QUERY LANGUAGE (KQL) may support streaming queries or provide a library or API for executing streaming queries. The streaming query 232 may be converted to code for performing the streaming query by inserting the streaming query 232 into corresponding function calls. In some implementations, the code component 199 may utilize the LLM 188 to generate the code 244. For instance, the code component 199 may generate a prompt 240 to the LLM 188 to generate the code 242 to perform the streaming query 232 in the programming language 234. For instance, the code component 199 may include the streaming query 232 output by the query component 196 and the programming language output by the location component 198 in the prompt 240. In some implementations, the code component 199 may verify or supplement the code 242 output by the LLM 188. The code component 199 may output final code 244 for use with an app 158. The code 244 may include different sets of code for execution at different locations to form a processing pipeline.

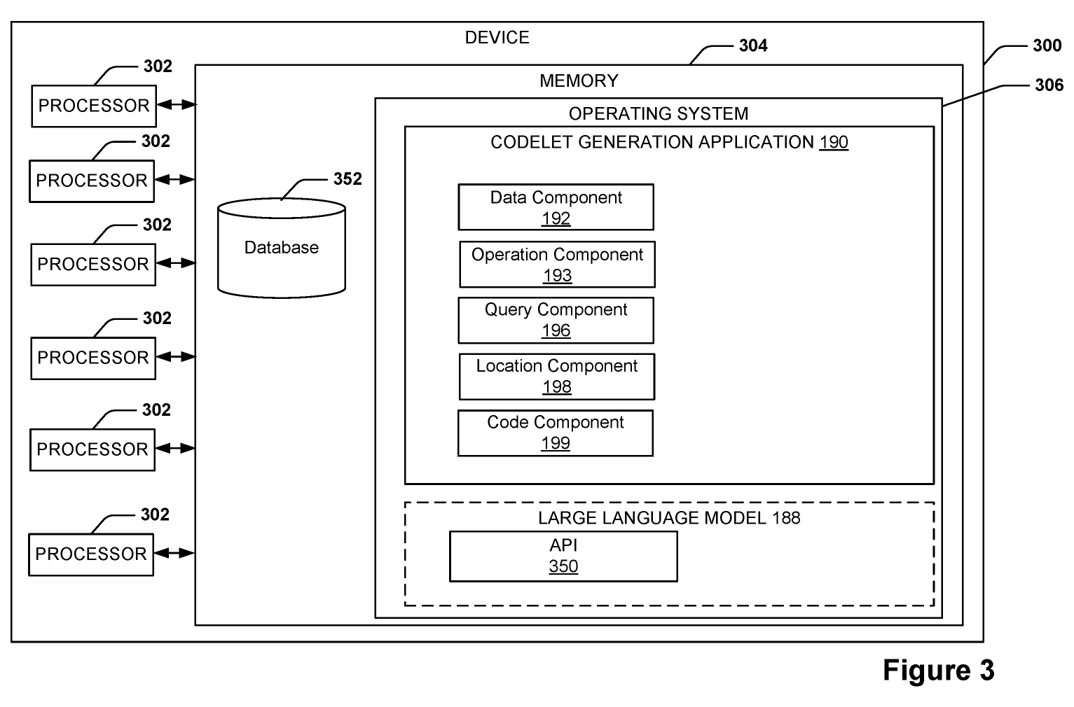

FIG. 3 is a schematic diagram of an example of an apparatus 300 (e.g., a computing device) for generating code for performing selected operations on selected data streams at one or more optimized locations within a communications network. The apparatus 300 may be implemented as one or more computing devices in the system 220.

In an example, the apparatus 300 includes at least one processor 302 and a memory 304 configured to execute or store instructions or other parameters related to providing an operating system 306, which can execute one or more applications or processes, such as, but not limited to, the abstraction layer application 190. For example, processors 302 and memory 304 may be separate components communicatively coupled by a bus (e.g., on a motherboard or other portion of a computing device, on an integrated circuit, such as a system on a chip (SoC), etc.), components integrated within one another (e.g., a processor 302 can include the memory 304 as an on-board component), and/or the like. Memory 304 may store instructions, parameters, data structures, etc. for use/execution by processor 302 to perform functions described herein. In some implementations, the memory 304 includes the database 352 for use by the abstraction layer application 190. In some implementations, the apparatus 300 includes the LLM 188, for example, as another application executing on the processors 302. Alternatively, the LLM 188 may be executed on a different device that may be accessed via an API 350.

In an example, the abstraction layer application 190 includes the data component 192, the operation component 194, the query component 196, the location component 198, and the code component 199 discussed above with respect to FIG. 1.

In some implementations, the apparatus 300 is implemented as a distributed processing system, for example, with multiple processors 302 and memories 304 distributed across physical systems such as servers, virtual machines, or datacenters 222. For example, one or more of the components of the abstraction layer application 190 may be implemented as services executing at different datacenters 222. The services may communicate via an API.

FIG. 4 is a flow diagram of an example of a method 400 for generating code for performing selected operations on selected data streams at one or more optimized locations within a communications network (e.g., a 5G network). For example, the method 400 can be performed by the abstraction layer application 190, the apparatus 300 and/or one or more components thereof to generate code 244 for apps 158.

At block 410, the method 400 includes receiving a selection of data elements available from one or more codelets operating within a network function or operating system of one or more nodes of a communications network, each data element associated with a schema defining output from the codelet. For example, in an aspect, apparatus 300, processor 302, memory 304, and/or abstraction layer application 190 and/or data component 192 may be configured to or may comprise means for receiving a selection of data elements 212 available from one or more codelets 132 operating within a network function or operating system of one or more nodes of a communications network (e.g., vRAN 100), each data element associated with a schema 230 defining output from the codelet. In some implementations, the selection of data elements includes data elements from a plurality of nodes of the communications network. For example, the selection of data elements may include data elements from different instances of a same network function or data elements from different types of network function.

At block 420, the method 400 includes receiving a selection of operations to perform an algorithm on one or more of the selected data elements. For example, in an aspect, apparatus 300, processor 302, memory 304, abstraction layer application 190, and/or operation component 194 may be configured to or may comprise means for receiving a selection of operations 214 to perform an algorithm on one or more of the selected data elements. In some implementations, the algorithm on the one or more of the selected data elements includes an aggregation or a transformation of the selection of data elements. For instance, example algorithms may include one or more of: tail statistics of a distribution of a data element during a window, percentile of a data element during a window, or an average of the data element during a window.

At block 430, the method 400 includes generating a streaming query that represents the algorithm for performing the operations on respective streams of the data elements. For example, in an aspect, apparatus 300, processor 302, memory 304, abstraction layer application 190, and/or query component 196 may be configured to or may comprise means for generating a streaming query that represents the algorithm for performing the operations on respective streams of the data elements.

At block 440, the method 400 includes selecting a location for performing the streaming query based on bandwidth and latency constraints. For example, in an aspect, apparatus 300, processor 302, memory 304, abstraction layer application 190, and/or location component 198 may be configured to or may comprise means for selecting a location for performing the streaming query based on bandwidth and latency constraints. In some implementations, the location for performing the streaming query is selected from a plurality of datacenters wherein at least two of the datacenters have different architectures. In some implementations, the output code 244 is configured to provide results of the streaming query to a machine-learning model 152 in a processing pipeline. For example, in some implementations, at sub-block 442, the block 440 may optionally include optimizing a latency metric or bandwidth metric for the processing pipeline from the codelet 132 to the machine-learning model 152.

At block 450, the method 400 includes outputting code in a programing language corresponding to an architecture of the selected location to perform the streaming query. For example, in an aspect, apparatus 300, processor 302, memory 304, abstraction layer application 190, and/or code component 199 may be configured to or may comprise means for outputting code in a programing language corresponding to an architecture of the selected location to perform the streaming query. For example, in some implementations, at sub-block 452, the block 450 may optionally include generating a prompt 240 to a large language model 188 to generate the code 242 to perform the streaming query 232 in the programming language 234. In some implementations, the output code is configured to provide results of the streaming query to a machine-learning model 152 in a processing pipeline. In some implementations, the output code may provide the results of the streaming query to a user interface or operations log.

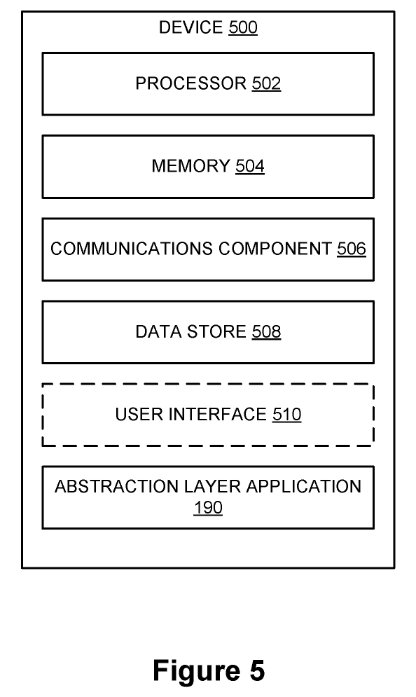

FIG. 5 illustrates an example of a device 500 including additional optional component details as those shown in FIG. 3. In one aspect, device 500 includes processor 502, which may be similar to processor 302 for carrying out processing functions associated with one or more of components and functions described herein. Processor 502 can include a single or multiple set of processors or multi-core processors. Moreover, processor 502 can be implemented as an integrated processing system and/or a distributed processing system.

Device 500 further includes memory 504, which may be similar to memory 304 such as for storing local versions of operating systems (or components thereof) and/or applications being executed by processor 502, such as the abstraction layer application 190, data component 192, operation component 194, query component 196, location component 198, code component 199, etc. Memory 504 can include a type of memory usable by a computer, such as random access memory (RAM), read only memory (ROM), tapes, magnetic discs, optical discs, volatile memory, non-volatile memory, and any combination thereof. The processor 502 may execute instructions stored on the memory 504 to cause the device 500 to perform the methods discussed above with respect to FIG. 4.

Further, device 500 includes a communications component 506 that provides for establishing and maintaining communications with one or more other devices, parties, entities, etc. utilizing hardware, software, and services as described herein. Communications component 506 carries communications between components on device 500, as well as between device 500 and external devices, such as devices located across a communications network and/or devices serially or locally connected to device 500. For example, communications component 506 may include one or more buses, and may further include transmit chain components and receive chain components associated with a wireless or wired transmitter and receiver, respectively, operable for interfacing with external devices.

Additionally, device 500 may include a data store 508, which can be any suitable combination of hardware and/or software, that provides for mass storage of information, databases, and programs employed in connection with aspects described herein. For example, data store 508 may be or may include a data repository for operating systems (or components thereof), applications, related parameters, etc. not currently being executed by processor 502. In addition, data store 508 may be a data repository for the abstraction layer application 190.

Device 500 may optionally include a user interface component 510 operable to receive inputs from a user of device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

Device 500 additionally includes the abstraction layer application 190 for generating code for performing selected operations on selected data streams at one or more optimized locations within a communications network (e.g., a 5G network).

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An apparatus comprising: one or more memories storing computer executable instructions; and one or more processors coupled with the one or more memories and, individually or in combination, configured to: receive a selection of data elements available from one or more codelets operating within a network function or an operating system of one or more nodes of a communications network, each data element associated with a schema defining output from a respective codelet; receive a selection of operations to perform an algorithm on one or more of the selected data elements; generate a streaming query that represents the algorithm for performing the operations on respective streams of the selected data elements; select a location for performing the streaming query based on bandwidth and latency constraints; and output code in a programing language corresponding to an architecture of the selected location to perform the streaming query.

Clause 2. The apparatus of clause 1, wherein the selection of data elements comprises data elements from a plurality of nodes of the communications network.

Clause 3. The apparatus of clause 1 or 2, wherein the algorithm on the one or more of the selected data elements includes an aggregation or a transformation of the selection of data elements.

Clause 4. The apparatus of clause 3, wherein the aggregation or the transformation includes one or more of: tail statistics of a distribution of a data element during a window, percentile of a data element during a window, or an average of the data element during a window.

Clause 5. The apparatus of any of clauses 1-4, wherein the location for performing the streaming query is selected from a plurality of datacenters wherein at least two of the datacenters have different architectures.

Clause 6. The apparatus of any of clauses 1-5, wherein the output code is configured to provide results of the streaming query to a machine-learning model in a processing pipeline.

Clause 7. The apparatus of clause 6, wherein to select the location, the one or more processors are configured to optimize a latency metric or bandwidth metric for the processing pipeline from the codelet to the machine-learning model.

Clause 8. The apparatus of any of clauses 1-7, wherein to output code in the programing language corresponding to the architecture of the selected location, the one or more processors are configured to generate a prompt to a large language model to generate the code to perform the streaming query in the programming language.

Clause 9. A method comprising: receiving a selection of data elements available from one or more codelets operating within a network function or an operating system of one or more nodes of a communications network, each data element associated with a schema defining output from a respective codelet; receiving a selection of operations to perform an algorithm on one or more of the selected data elements; generating a streaming query that represents of the algorithm for performing the operations on respective streams of the selected data elements; selecting a location for performing the streaming query based on bandwidth and latency constraints; and outputting code in a programing language corresponding to an architecture of the selected location to perform the streaming query.

Clause 10. The method of clause 9, wherein the selection of data elements comprises data elements from a plurality of nodes of the communications network.

Clause 11. The method of clause 9 or 10, wherein the algorithm on the one or more of the selected data elements includes an aggregation or a transformation of the selection of data elements.

Clause 12. The method of clause 11, wherein the aggregation or the transformation includes one or more of: tail statistics of a distribution of a data element during a window, percentile of a data element during a window, or an average of the data element during a window.

Clause 13. The method of any of clauses 9-12, wherein the location for performing the streaming query is selected from a plurality of datacenters wherein at least two of the datacenters have different architectures.

Clause 14. The method of any of clauses 9-13, wherein the output code is configured to provide results of the streaming query to a machine-learning model in a processing pipeline.

Clause 15. The method of clause 14, wherein selecting the location comprises optimizing a latency metric or bandwidth metric for the processing pipeline from the codelet to the machine-learning model.

Clause 16. The method of any of clauses 9-14, wherein outputting code in the programing language corresponding to the architecture of the selected location comprises generating a prompt to a large language model to generate the code to perform the streaming query in the programming language.

Clause 17. A non-transitory computer-readable medium having computer-executable instructions stored thereon, the instructions when executed by a computer processor cause the computer processor to perform the method of any of clauses 9-16.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus comprising:
one or more memories storing computer executable instructions; and
one or more processors coupled with the one or more memories and, individually or in combination, configured to:
receive a selection of data elements available from one or more codelets operating within a network function or an operating system of one or more nodes of a communications network, each data element associated with a schema defining output from a respective codelet;
receive a selection of operations to perform an algorithm on one or more of the selected data elements;
generate a streaming query that represents the algorithm for performing the operations on respective streams of the selected data elements;
select a location for performing the streaming query based on bandwidth and latency constraints; and
output code in a programing language corresponding to an architecture of the selected location to perform the streaming query.

2. The apparatus of claim 1, wherein the selection of data elements comprises data elements from a plurality of nodes of the communications network.

3. The apparatus of claim 1, wherein the algorithm on the one or more of the selected data elements includes an aggregation or a transformation of the selection of data elements.

4. The apparatus of claim 3, wherein the aggregation or the transformation includes one or more of: tail statistics of a distribution of a data element during a window, percentile of a data element during a window, or an average of the data element during a window.

5. The apparatus of claim 1, wherein the location for performing the streaming query is selected from a plurality of datacenters wherein at least two of the datacenters have different architectures.

6. The apparatus of claim 1, wherein the output code is configured to provide results of the streaming query to a machine-learning model in a processing pipeline.

7. The apparatus of claim 6, wherein to select the location, the one or more processors are configured to optimize a latency metric or bandwidth metric for the processing pipeline from the codelet to the machine-learning model.

8. The apparatus of claim 1, wherein to output code in the programing language corresponding to the architecture of the selected location, the one or more processors are configured to generate a prompt to a large language model to generate the code to perform the streaming query in the programming language.

9. A method comprising:
receiving a selection of data elements available from one or more codelets operating within a network function or an operating system of one or more nodes of a communications network, each data element associated with a schema defining output from a respective codelet;
receiving a selection of operations to perform an algorithm on one or more of the selected data elements;
generating a streaming query that represents of the algorithm for performing the operations on respective streams of the selected data elements;
selecting a location for performing the streaming query based on bandwidth and latency constraints; and
outputting code in a programing language corresponding to an architecture of the selected location to perform the streaming query.

10. The method of claim 9, wherein the selection of data elements comprises data elements from a plurality of nodes of the communications network.

11. The method of claim 9, wherein the algorithm on the one or more of the selected data elements includes an aggregation or a transformation of the selection of data elements.

12. The method of claim 11, wherein the aggregation or the transformation includes one or more of: tail statistics of a distribution of a data element during a window, percentile of a data element during a window, or an average of the data element during a window.

13. The method of claim 9, wherein the location for performing the streaming query is selected from a plurality of datacenters wherein at least two of the datacenters have different architectures.

14. The method of claim 9, wherein the output code is configured to provide results of the streaming query to a machine-learning model in a processing pipeline.

15. The method of claim 14, wherein selecting the location comprises optimizing a latency metric or bandwidth metric for the processing pipeline from the codelet to the machine-learning model.

16. The method of claim 9, wherein outputting code in the programing language corresponding to the architecture of the selected location comprises generating a prompt to a large language model to generate the code to perform the streaming query in the programming language.

17. A non-transitory computer-readable medium having computer-executable instructions stored thereon, the instructions when executed by a computer processor cause the computer processor to:
receive a selection of data elements available from one or more codelets operating within a network function or an operating system of one or more nodes of a 5G radio network, each data element associated with a schema defining output from a respective codelet;
receive a selection of operations to perform an algorithm on one or more of the selected data elements;
generate a streaming query that represents the algorithm for performing the operations on respective streams of the selected data elements;
select a location for performing the streaming query based on bandwidth and latency constraints; and
output code in a programing language corresponding to an architecture of the selected location to generate inputs to a machine-learning model by performing the streaming query.

18. The non-transitory computer-readable medium of claim 17, wherein the selection of data elements comprises data elements from a plurality of nodes of the communications network.

19. The non-transitory computer-readable medium of claim 17, wherein the algorithm on the one or more of the selected data elements includes an aggregation or a transformation of the selection of data elements.

20. The non-transitory computer-readable medium of claim 17, wherein the location for performing the streaming query is selected from a plurality of datacenters wherein at least two of the datacenters have different architectures.
